(19) United States
(12) Patent Application Publication
(10) Pub. No.: US 2007/0294398 A1
(43) Pub. Date: Dec. 20, 2007

(54) System and method of dynamically persisting data and settings to a network location

(76) Inventor: Alan J. Epshteyn, Miller Place, NY (US)

Correspondence Address: FAY KAPLUN & MARCIN, LLP, 15O BROADWAY, SUITE 702, NEW YORK, NY, 10038, US

(21) Appl. No.: 11/455,558

(22) Filed: Jun. 19, 2006

(51) Int. Cl. G06F 15/173

(52) U.S. Cl. 709/224

(57) ABSTRACT

Described is a system and method for dynamically persisting data and settings to a network location. The system may include a network device which receives wireless communications from a mobile unit. The wireless communications may include user information for the mobile unit to be stored. The system may also include a network storage device which receives and stores the user information. The network storage device makes the user information available for retrieval by the user.

### BACKGROUND

Mobile units (MU) such as personal digital assistants (PDA) are relied on for business and personal use in a wide variety of applications. MUs generally include a storage and a memory where a user stores personal data and settings for the MU. PDAs are computing devices and are subject to the problems associated with all computing devices, such as hard disk or other memory failure, processor failure, etc. In addition, since PDAs are mobile, there is the additional risk of misplacing or losing the device. When the device is lost or suffers a catastrophic failure, the personal data and settings are lost to the user.

Current technology utilizes synchronization software for PDAs where a user may store data entered into the PDA into a database. The database is often a personal computer that is used by the user. Current technology also utilizes network databases where a user may store data entered into the PDA in a central database. However, these methods require a user to actively initiate the synchronization (e.g., place PDA in a cradle, initiate a synchronization program, physically connect a cable to the device, etc.). In addition, current technology is limited to storing data only. Thus, when a PDA is lost or experiences a catastrophic failure, only the last synchronized data on the database is recoverable. The user must take the time consuming step of manually resetting all the personal settings on the new or repaired PDA.

### SUMMARY OF THE INVENTION

The present invention relates to a system and method for dynamically persisting data and settings to a network location. The system may include a network device which receives wireless communications from a mobile unit. The wireless communications may include user information for the mobile unit to be stored. The system may also include a network storage device which receives and stores the user information. The network storage device makes the user information available for retrieval by the user.

### DESCRIPTION OF THE DRAWINGS

FIG. 1 illustrates an exemplary system including a mobile unit that stores information into a database through a wireless network according to the present invention.

FIG. 2 illustrates an exemplary method of continuous updating of information on a network location according to an exemplary embodiment of the present invention.

FIG. 3 illustrates an exemplary format of the network location for storing information according to the exemplary embodiment of the present invention.

### DETAILED DESCRIPTION

The present invention may be further understood with reference to the following description and the appended drawings, wherein like elements are referred to with the same reference numerals. The exemplary embodiment of the present invention describes a system and method for persisting user information of a mobile unit (MU) to a network location. The term “user information” or “information” refers to any information that may be stored on the MU. Examples of information include data such as addresses, phone numbers, etc. and settings such as wireless settings, screen settings, etc. However, those skilled in the art will understand that any type of information that is stored on the MU may be persisted. The term persisting refers to a constant updating or synchronizing of the data, settings, or other information existing on the MU to the network location. The method of persisting will be described in detail below. It should be noted that the term “network location” is used interchangeably with the term “network database” throughout this disclosure and these terms are used to denote one or more locations when the data and settings may be stored for later recovery.

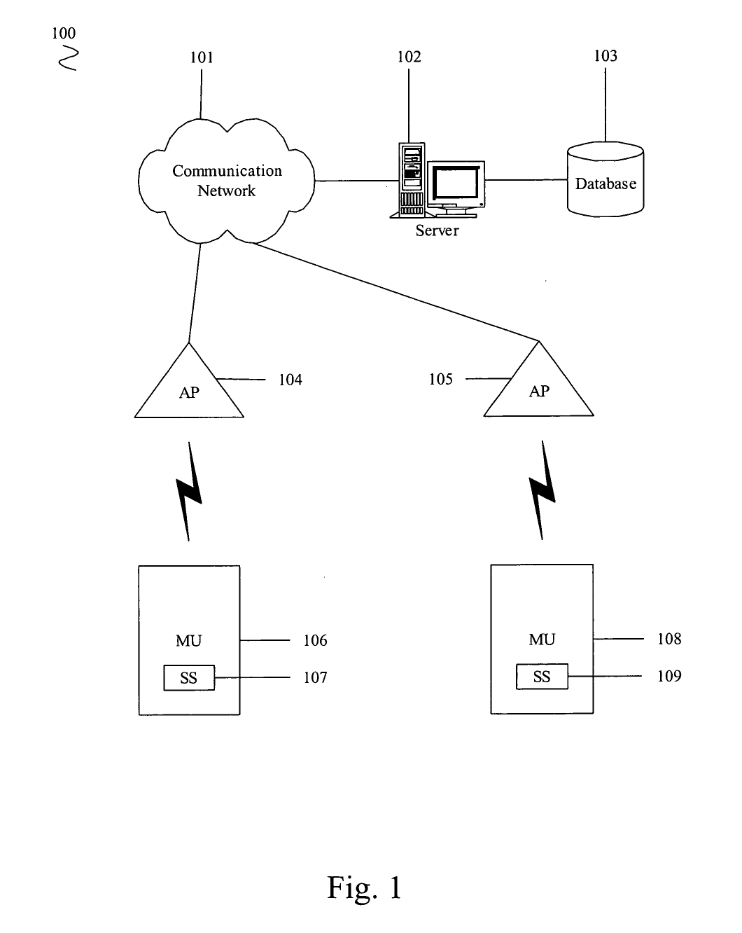

FIG. 1 illustrates an exemplary system 100 in which the present invention may be implemented. Those skilled in the art will understand that the described system 100 is only exemplary and that there are many different systems and networks on which the present invention may be implemented. The system 100 includes a communication network 101 connecting a server 102 and access points (AP) 104, 105. The server 102 is also connected to a network database 103 which may be used as a storage unit that holds information for the communications network 101, the server 102, the APs 104, 105, and any other device that may be directly or indirectly connected to it.

It should be noted that the use of a single database 103 is exemplary only and that other configurations exist. For example, a single database may be used as the storage unit for each component that is connected to it. That is, one database serves the server 102, one database serves the communication network 101, one database serves one access point, etc. In another example, the network database may not be connected directly to the server 102, but may be accessed via the communications network 101.

The APs 104, 105 facilitate communication between wireless communication devices and other devices connected to the communication network 101. The wireless communication devices that connect to the network 101 via the APs 104, 105 are mobile units (MU) 106, 108. There are various known methods for connecting a wireless MU to a network and these methods will not be discussed in detail herein. In order to maintain a connection with the communication network 101, the MUs 106, 108 must stay within the service area of the APs 104, 105. If the MUs 106, 108 exit the service area of the APs 104, 105 and are not within a service area of another AP, then the MU is no longer connected to the communication network 101. A disconnection may also occur if the MU enters a “down” spot within the service area of the AP. For example, a “down” spot may be within a building, underground, or in a tunnel. If the disconnected MU reenters a service area of an AP, it may reconnect to the communication network 101. The MUs 106, 108 may also contain synchronization software (SS) 107, 109 that are used to synchronize local data of the MUs 106, 108 with the network data of the database 103. The synchronization software will be described in greater detail below.

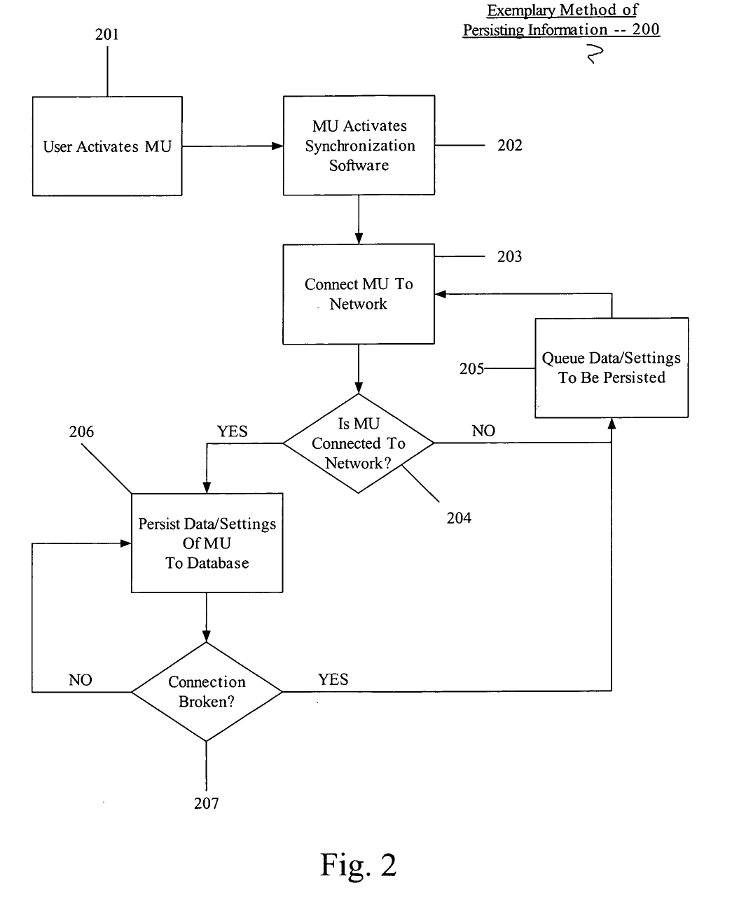

FIG. 2 illustrates an exemplary method 200 of persisting information to a network location according to an exemplary embodiment of the present invention. FIG. 2 will be described with reference to the system 100 described in FIG. 1. The information that is persisted may include data, personal settings of the MU 106, 108, or any other information that is stored in the MUs. By storing data and personal settings, if a user should lose or suffer catastrophic failure of a MU, a “fresh” MU (e.g., new MU or reformatted MU) may load all information that was persisted in the network database 103. This essentially restores the fresh MU to one that the user was using prior to the loss or failure without requiring the user to manually reset the data and/or settings of the fresh MU.

Initially, the method 200 starts with step 201 where the user activates the MU. For the purpose of illustration, the method 200 will be described with reference to MU 106 connecting to the communication network 101 via AP 104. Thus, in step 201, the user activates MU 106. At step 202, the MU 106 activates the synchronization software 107, e.g., the synchronization software 107 is part of the start-up routine of the MU 106. It should be noted that the automatically activated synchronization software 107 may be deactivated if the user wishes to do so (e.g., to free up any memory allocated to the software, the user is aware that the area is definitely outside a service area of an AP 104, etc.). However, under normal circumstances, the synchronization software 107 will be running in the background while the MU 106 is activated.

The synchronization software 107 attempts to connect to the network 101 (i.e., step 203) through the AP 104. It should be noted that the synchronization software 107 may not perform the connection functions, e.g., the synchronization software may call a network connectivity application to connect to the communication network 101. In another example, the network connection functionality may be part of the start-up procedure of the MU 106, e.g., where the MU 106 is activated, the network connection functionality is part of the start-up routine to connect the MU 106 to the communication network 101. Thus, the step 203 may be included as part of the synchronization software 107 or it may be included as other functionality in the MU 106.

Before the synchronization software 107 attempts to persist the data of the MU 106 to the network database 103, the synchronization software 107 confirms that a connection with the communication network 101 is established, i.e., step 204. If step 204 determines that a connection to the communication network 101 is not established, then the method may proceed to step 205, where the synchronization software 107 queues any information to be persisted on the network database 103. The method for queuing data/settings in step 205 is similar to persisting of data/settings in step 206 and will be described in detail below. It should be noted that the synchronization software 107 may bypass step 205 and go back to step 203 where another attempt at connecting the MU 106 to the communication network 101 occurs. It should also be noted that the synchronization software 107 may not have a step 205. If step 204 confirms that a connection is established with the communication network 101, then the method proceeds to step 206 where the information (e.g., data, settings, etc.) of the MU 106 is persisted to the network database 103.

At step 206, it has been verified that an active connection with the communication network 101 is maintained by the MU 106. Through this active connection, the persisting of information is done in real-time as data and/or settings are changed. The synchronization software 107 runs in the background and monitors the user's activity on the MU 106. If the user enters new data, changes existing data, enters a new setting, etc., the synchronization software 107 notes the change to the information on the MU 106 and determines that this new information should be persisted into the network database 103. For example, if a user creates or updates data, that data is persisted to the network database 103. If a user changes a personal setting on the MU 106, that setting is persisted to the network database 103. Thus, the exemplary method of persisting information 200 according to the embodiment of the present invention does not require any user interaction. The synchronization software 107 detects the information update and persists this update to the network database 103. It should also be noted that the synchronization software 107 does not exclusively monitor user activity, as information changes or updates may also be recorded as a result of information received from the communication network 101 or other applications running on the MU 106. Thus, the synchronization software 107 may monitor for any new/updated information on the MU 106.

There are several methods for which the present invention may implement a real-time persisting of the information of the MU 106 to the network database 103. For example, the persisting may be done based on a timer. The timer indicates when a synchronization occurs (e.g., once a minute, 5 minutes, 10 minutes). In the timer example, the synchronization software 107 may send any changes that occurred since the last transmission of information to be persisted based on the timer interval. In another example, the persisting may be based on a change. Upon detecting a change in data and/or settings, the synchronization software 107 immediately persists the changes to the network database 103. In a third example, the synchronization may be based on a connectivity of the MU 106 to the communication network 101. For example, the remote persistence may be enabled when the MU 106 is connected to the network 101 via a wireless local area network (WLAN) but disabled when only a wide area network (WAN) connectivity is available. It should be noted that these examples of persistence are exemplary only and that other examples exist. It should also be noted that the above discussed examples may be used alone or in combination. For example, the synchronization software 108 may persist the information using both a change indicator and a timer (i.e., persisting occurs whenever a change occurs and when a timer dictates).

The information that is persisted may be sent to the network database 103 from the MU 106 in any number of different manners. For example, the user of the MU 106 (or the system administrator) may determine that the persisting is an important function for the user. In such a case, the information that is persisted may be bundled as a unique message each time that the persisting is going to take place, e.g., the MU 106 formats a message solely for the purpose of transmitting the information to be persisted. In another example, the system 100 may send the information to be persisted in a manner that efficiently controls the number of transmissions made by the MU. For example, the information may be sent within another communications packet bound for the communication network 101. Those skilled in the art will understand that some communications protocols include empty space in frames or packets that may be utilized to communicate additional information. Thus, the information to be persisted may be included within empty frames of other communications between the MU 106 and the communications network 101. In such an embodiment, a tag within the header of the packet may include information to indicate that the packet includes data to be persisted, e.g., the server 102 interprets the tag and persists certain information contained within the packet to the network database 103. It should be noted that these methods of persisting may be used in combination. That is, for example, information that is important (e.g., data) may use a unique message, while empty frames of another packet may be used for information that is deemed not as important (e.g., settings). It should also be noted that these methods of persisting may be done in conjunction with any of the real-time persisting methods described above. Furthermore, the method of persisting may be user settable based on considerations such as network throughput, etc.

In order to continue the persisting in real-time, the synchronization software 107 uses step 207 to determine if the MU 106 is still connected to the communication network 101. Specifically, it determines if the connection to the communication network 101 is broken. If in step 207, it is determined that the connection is not broken, then the synchronization software 108 continues to persist the information of the MU 106 to the network database 103, as detailed in step 206. However, if it is determined in step 207 that the connection has been broken, then the method returns to step 205 (i.e., attempts to connect to the network 101). It should be noted that step 207 may be performed in several ways. For example, the synchronization software 107 may receive a periodic signal from the connectivity application indicating that the connection is active/inactive. In another example, the synchronization software 107 may request the status of the connection prior to each occurrence of persisting of data and settings.

Thus, if there is no connection to the communication network 101 detected in step 204 or the connection is broken in step 207, the synchronization software 107 will queue the data/settings to be persisted in step 205. The information will be queued in the same manner as described for persisting the information, e.g., the synchronization software 107 monitors the MU 106 for changes/additions/deletions of data/settings. However, because there is no active connection to persist this information to the network database 103, the synchronization software 107 stores the information on the MU 106, for example, on a hard drive, flash drive, etc. When the connection becomes active, the information is then persisted to the network database 103.

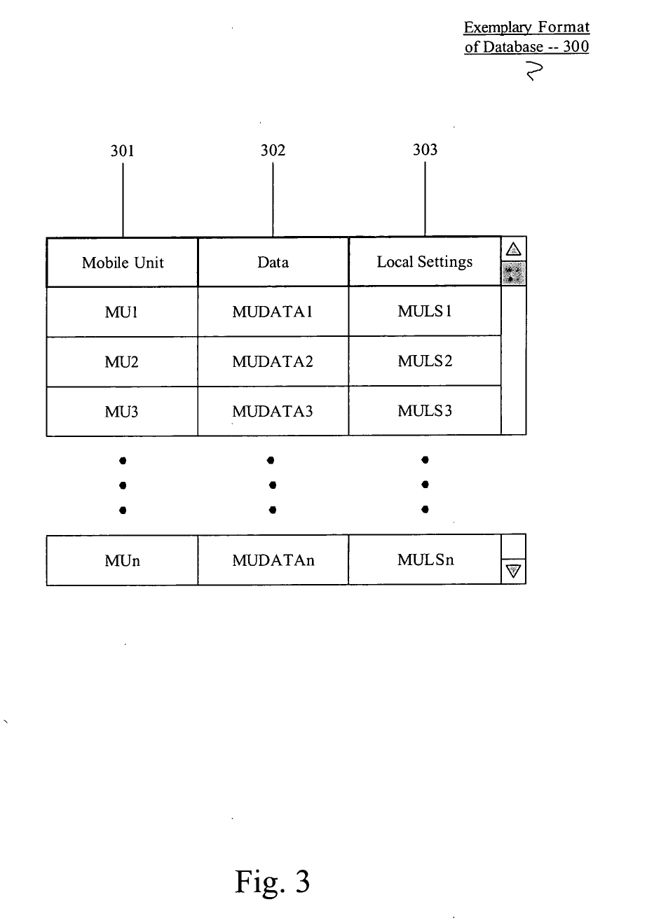

FIG. 3 illustrates an exemplary format 300 for storing information of the MU 106, 108 on the network database 103 according to an exemplary embodiment of the present invention. The format 300 includes a column 301 for identifying a mobile unit (e.g., MU 106, 108), a column 302 for data that is on the MU, and a column 303 for local settings (e.g., personal preferences) that is on the MU. Those skilled in the art will understand that the column format for saving data/settings is only exemplary and that other formats may also be employed. The format 300 may be displayed, for example, as a spreadsheet in a database format, etc. In the exemplary embodiment, column 301 includes MU from MU1 to MUn. Column 302 includes data of a MU from MUDATA1 to MUDATAn. Column 303 includes local settings of a MU from MULS1 to MULSn. The data that is saved in column 302 may be, for example, an address book for a program on the MU, a telephone directory, memos, calendar events, pictures, and documents. The local settings that are saved in column 303 may be, for example, a volume, a contrast, a background image, and shortcut preferences. It should be noted that the examples of the data and local settings discussed above are exemplary only and that other data and local settings may exist.

The data in column 302 may be saved in the network database 103 as individual files that correspond to the program with which the data is associated. For example, an address book on the MU 106 may store data in one or more files having a particular format and/or file extensions. The network database 103 may store corresponding files indicating their association with the address book. Furthermore, a plurality of files or records that are associated with a particular MU may be linked using, for example, pointers. The local settings in column 303 may be saved in the network database 103 as individual files as well to correspond to the type of local setting it represents. However, in terms of the local settings, the network database 103 may save the local settings as a single file that associates all possible local settings that the MU 106, 108 may incorporate. As would be understood by those skilled in the art, it should be noted that the single file should correspond to the operating system that is installed on the MU 106, 108.

The present invention permits many different ways for a user to retrieve the data/settings upon losing the MU or suffering a catastrophic failure of the MU. Those skilled in the art will understand that retrieval of information from a network database is also possible when a communication system is set up for persisting data/settings to the network database, i.e., sending information is also possible if the communication network is set up to receive information.

For example, in one exemplary embodiment, a user may connect the new or repaired MU to the network database to retrieve the personal data/settings. If the MU is not connected to the communication network at the time the data/settings retrieval task is activated, the MU may queue this task to be performed upon the MU connecting to the communication network. It should be noted that the communication system may also provide a security measure for retrieval of information. For example, a user may be required to provide information (e.g., user identification, password, MU serial number, etc.) to ensure that the user has permission to retrieve the data/settings saved on the network database.

In another exemplary embodiment for data/settings retrieval, a user may contact a system administrator of the network database that stored the user's data/settings. The system administrator may perform the retrieval of data/settings for the user. It should be noted that a security measure may also be provided. For example, the system administrator may only access a user's data/settings upon contact from the user. Further, the system administrator provides information (e.g., system administrator identification, administrator password, etc.) to access the network database. The security measure may also require that the user provides information (e.g., user identification, password, MU serial number, etc.) to the network administrator. The system administrator may perform the data/settings retrieval in many ways. For example, if the MU is already connected to the communication network, the system administrator may send the user's data/settings immediately. In another example, if the MU is not connected to the communication network, the system administrator may assign a task to the server to perform the retrieval from the network database once the MU connects to the communication network.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A method, comprising:
monitoring a wirelessly enabled mobile unit to determine whether user information has changed;
determining whether the mobile unit is connected to a network; and
persisting the changed user information to a network location.

2. The method of claim 1, wherein the user information includes one of data and settings.

3. The method of claim 1, further comprising:
queuing the user information to be persisted if the mobile unit is not connected to the network.

4. The method of claim 1, wherein the persisting is further based on a timer.

5. The method of claim 1, further comprising:
detecting a disconnection of the mobile unit from the network, the detecting being based on one of a timer and a change indicator, prior to reconnecting the mobile unit.

6. The method of claim 1, wherein the network location is a network database.

7. The method of claim 1, further comprising:
retrieving the data and settings from the network location to the mobile unit.

8. The method of claim 7, further comprising:
performing a security measure to allow the retrieving.

9. A system, comprising:
a network device receiving wireless communications from a mobile unit, the wireless communications including user information for the mobile unit to be stored; and
a network storage device receiving and storing the user information, the network storage device making the user information available for retrieval by the user.

10. The system of claim 9, wherein the user information includes one of data and user settings.

11. The system of claim 9, wherein the network storage device includes a database for storing the user information.

12. The system of claim 9, wherein a user identification is required to retrieve the user-information.

13. A device, comprising:
first means for wirelessly communicating with a network;
second means for determining whether user information has changed on the device; and
third means for communicating the changed user information to a network location via the wireless communication arrangement.

14. The device of claim 13, further comprising:
fourth means for confirming a connection to the network.

15. The device of claim 13, further comprising:
fifth means for queuing the user information to be persisted if the device is not connected to the network.

16. The device of claim 13, wherein the network location is a network database.

17. The device of claim 13, further comprising:
sixth means for retrieving the user information from the network location to the device.

18. The device of claim 17, wherein the sixth means performs a security measure to allow the retrieving.

19. The device of claim 13, wherein the user information includes one of data and settings.

20. The device of claim 13, wherein addition of new user information is a change of the user information.

21. A device, comprising:
a wireless communication arrangement communicating with a communications network; and
a processor determining if user information has changed on the device, the processor communicating the changed user information to a network location via the wireless communication arrangement.
